(19) United States
(12) Patent Application Publication
(10) Pub. No.: US 2005/0153737 A1
(43) Pub. Date: Jul. 14, 2005

(54) Handheld electronic device comprising a bi-stable body

(75) Inventor: Keith Bailey, Basingstoke (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/021,004

(22) Filed: Dec. 22, 2004

(30) Foreign Application Priority Data
Dec. 23, 2003 (GB) 0329853.6

(51) Int. Cl. E05C 19/00; H04M 1/00

(52) U.S. Cl. 455/556.1

(57) ABSTRACT

A handheld electronic device including a body, wherein said body comprises a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations.

### FIELD OF INVENTION

The invention relates to a cover for a handheld electronic device. More specifically, the present invention relates to a cover for a mobile phone.

### BACKGROUND OF THE INVENTION

A problem with known handheld electronic devices is that they have become so small that they are difficult to hold, manipulate and operate. In particular, they are difficult to both hold and operate at the same time.

Another problem with known handheld electronic devices is that of operating buttons on the device by accident while carrying the device around. The device may also be damaged while being carried around. For example, a screen of the device may be scratched or broken.

A further problem more specific to mobile phone devices is that they have become so small that in use they no longer cover the mouth and ear of the user at the same time. That is, ear-mouth coverage is poor due to the smaller size of modern devices. This can lead to poor sound quality for both caller and recipient. Furthermore, there is a reduction in the degree of privacy in that a user's mouth is not obscured by the phone while talking. Small handsets may also provide an uncomfortable grip. With small phones the user has to hold his/her arm higher in order to hold the phone to his/her ear which can be strenuous and uncomfortable.

Known mechanical solutions to the above-described problems include the implementation of a flip design, a slide design, a rotational design or a clamshell/fold design. These solutions allow for the handheld electronic device to be carried around in a configuration which is small in size when not in use. Furthermore, buttons/keys on the device may be covered by at least a portion of the casing when in this configuration so as to prevent accidental operation and/or damage. The handheld electronic device may then by reconfigured into an operational configuration which is generally larger in size and better shaped to allow a user to both hold and operate the device.

All these prior arrangements include hinges or other mechanical parts liable to breakage/wear over time. Furthermore, the hinges/mechanical parts themselves can lead to an increase in the size of the device, particularly in a non-operational or folded configuration. These prior art arrangements are also complicated in structure and difficult to manufacture which leads to an increase in cost. The prior art arrangements also often require a user to use both hands to move the device between the closed configuration and the open/operational configuration.

An aim of embodiments described hereinafter is to solve the problems outlined above.

According to a first aspect of the present invention there is provided a handheld electronic device comprising a body, wherein said body comprises a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations.

According to a second aspect of the present invention there is provided a housing for a handheld electronic device, said housing comprising a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations.

According to a third aspect of the present invention there is provided a method of using a handheld electronic device wherein the first and second portions are moved between the first configuration and the second configuration by the application of a squeezing force applied by a user's hand.

According to a fourth aspect of the present invention there is provided an electronic device comprising a body, wherein said body comprises a first portion, a second portion and an intermediate portion, said intermediate portion connecting the first and second portions, said first and second portions being movable relative to each other between a first configuration and a second configurations, said intermediate portion being formed of a bi-stable material which has two stable configurations corresponding to said first and second configurations.

Embodiments of the present invention provide a handheld electronic device having a body which is movable between a closed or inoperative position and an open or operative position without the use of hinges and/or other mechanical parts liable to breakage/wear over time. Embodiments of the present invention have all the advantages of the previous hinge type solutions i.e. easier to hold and operate in an operational configuration while being a small size and protected from damage and accidental operation in an inoperative. In one embodiment, the body may only partially cover a user interface such that part/all of a display remains visibly/operable and basic features (eg clock, Caller Line Identification) may still be used in the closed position. Furthermore, as embodiments of the present invention avoid the use of hinges/mechanical parts, a handheld electronic device according to the present invention has additional advantages over prior art solutions. Embodiments of the present invention can be made to be smaller in their closed or inoperative configuration through avoidance of bulky mechanical arrangements. Avoiding the use of hinges or other complicated mechanical parts makes embodiments of the present invention less liable to breakage/wear over time. Furthermore, as embodiments of the present invention are less complicated in structure they are easier and cheaper to manufacture.

In the closed/inoperable configuration, the device may still be operating. For example, a mobile phone would still be operating in the sense of being connected to a network even when closed. Furthermore, it may be possible to make/take a call with the device closed.

In one embodiment, the body is integral with the handheld electronic device. In an alternative embodiment of the invention the body is provided as a separate housing for fixing to a handheld electronic device.

Embodiments of the invention which are mobile phones also solve the problem of poor ear-mouth coverage by providing a mouthpiece and/or an earpiece for a mono-block type mobile phone. The provision of an extendable mouthpiece and/or earpiece provides an improvement in sound quality and privacy during use.

### BRIEF DESCRIPTION OF THE DRAWINGS

For a better understanding of the present invention and to show how the same may be carried into effect reference will not be made by way of example to the accompanying drawings in which:

FIG. 1 shows a block representation of a small product shown next to a pencil to illustrate scale;

FIG. 2 shows how a bi-stable cover according to the present invention can be folded around a small product to serve as a housing for the product;

FIG. 3 shows the bi-stable housing of FIG. 2 in an open configuration after application by a user of pressure to left and right hand edges of housing;

FIG. 4 shows an embodiment of a mobile phone comprising a bi-stable body in a closed configuration according to an embodiment of the present invention;

FIG. 5 shows the embodiment of FIG. 4 with the bi-stable body in an open configuration.

### DETAILED DESCRIPTION OF THE EMBODIMENTS OF THE INVENTION

The invention utilises the properties of a bi-stable material. The bi-stable material has two stable configurations. In a first stable configuration the material provides a body or housing for a hand held electronic device in a “closed” configuration. By the application of a force by a user to the bi-stable material at one or more locations (for example, a squeezing force on opposing sides of the material), the body or housing is actuated from the closed configuration to an “open” configuration. In the open configuration the hand held electronic device may be operated by a user. When the user has finished operating the device, the body or housing may be moved to a closed configuration by applying a force to the bi-stable material at one or more locations which may be the same or different to the locations for opening the device (for example, a force applied to an end portion of the material).

The principle behind the present invention will now be described with reference to FIGS. 1 to 3.

FIG. 1 shows a block representation of a small product 2 shown next to a pencil for scale.

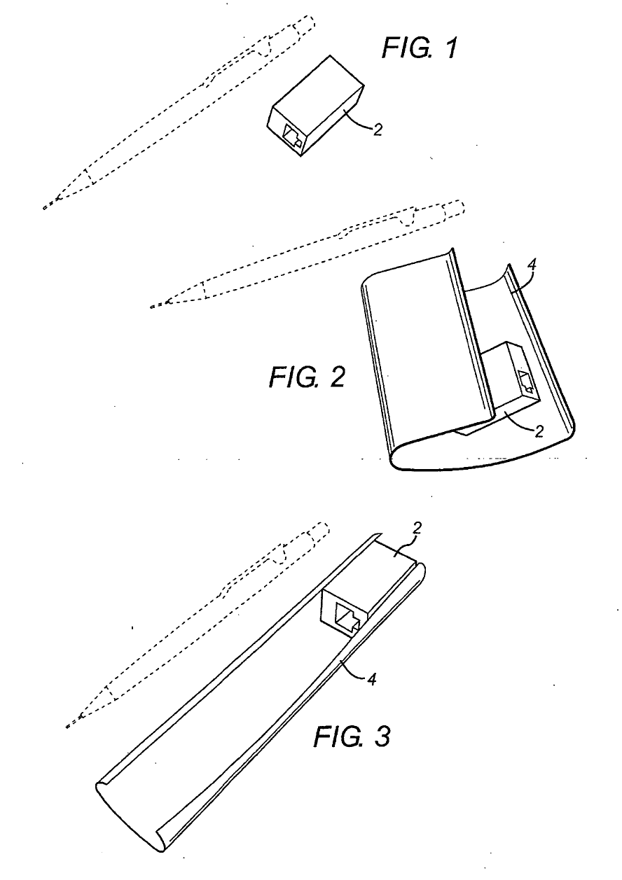

FIG. 2 shows a bi-stable material 4 being folded around the small product 2 shown in FIG. 1. The bi-stable material is folded into a first stable configuration. In this closed configuration the small product is surrounded by the material. In particular a front face of the small product is covered by a portion of the bi-stable material.

FIG. 3 shows the configuration of the bi-stable material after the application of a squeezing force to left and right hand sides of the bi-stable material. The application of a squeezing force causes the bi-stable material to move between the first, closed configuration shown in FIG. 2 and a second stable configuration shown in FIG. 3. In this open configuration the front face of the small product is accessible by a user for operation of the product. A portion of the bi-stable material extends from the product. Thus the size of the product comprising the bi-stable material is increased in the open configuration as compared with the closed configuration. This facilitates use of the product as it is easier to both hold and operate as compared with a small product without the bi-stable material. An inner surface of the portion of bi-stable material which extends from the product is also exposed in this configuration and is accessible by a user. This inner surface may support additional elements of the product. For example, a mouthpiece of a mobile phone may be mounted on this surface. Alternatively, the front surface of the product may comprise a display with keys for operating the device mounted on the inner surface of the bi-stable material so as to be accessible in the open configuration. Applying a pushing force to the extended portion of bi-stable material at, for example, a rear surface thereof causes the bi-stable material to revert to the closed configuration.

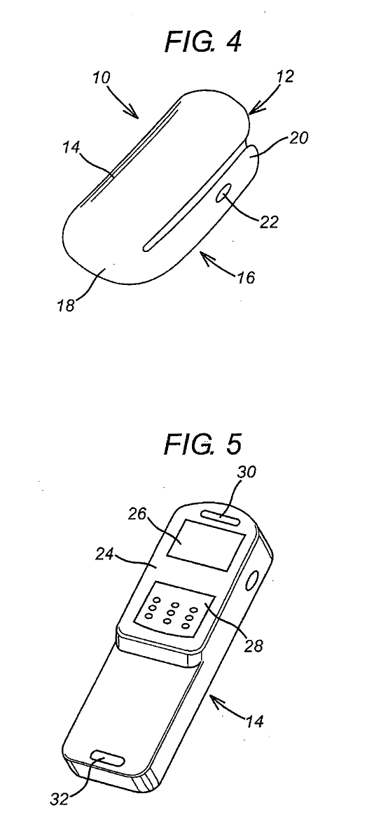

An embodiment of a mobile phone comprising a bi-stable cover according to the present invention will now be described with reference to FIGS. 4 and 5.

FIG. 4 shows a mobile phone 10 having a body 12 comprising a bi-stable material. The body includes an engine and a housing. In FIG. 4, the phone 10 is in a closed configuration. The body 12 of the phone 10 is folded to have two opposed portions, a front portion 14 and a rear portion 16. An intermediate portion 18 connects the two opposed portions 14, 16. The body also has two side walls 20.

The body 12 comprises a bi-stable material. The bi-stable material comprises a continuous element or component which forms at least a portion of the front portion 14, the intermediate portion 18 and the rear portion 16 of the body. A bi-stable fold is provided in the bi-stable element in the intermediate portion 18. In this configuration the bi-stable material is folded into a first stable configuration. In this closed configuration the phone components (keypad, display, etc . . . ) are surrounded by the body. In particular a front face of the phone is covered by the body. In the presently illustrated embodiment, at least a portion of the side walls 20 also comprises the bi-stable material element and contact areas 22 are marked on either side wall indicating the location at which the user is to apply a squeezing force. In an alternative embodiment, the bi-stable material does not comprise a portion of the side walls but rather only comprises a portion of the front portion 14, the intermediate portion 18 and the rear portion 16 of the body. In another alternative embodiment, the bi-stable material does not comprise a portion of the side walls or the rear portion 16, but rather only comprises a portion of the front portion 14 and the intermediate portion 18 of the body

The application of a squeezing force to the two contact areas 22 causes the bi-stable material element to move from the first stable configuration to a second stable configuration thus causing the body to move into an open configuration as illustrated in FIG. 5.

In this open configuration a front face 24 of the mobile phone is accessible by a user for operation of the phone. The front face 24 comprise a display 26, a keypad 28 and an ear-piece 30. The front portion 14 of the body now extends away from the front face 24. The front and rear portions 14, 16 are no longer opposed but rather extend in a plane or in an angled configuration to fit the contours of a user's face. An inner surface of the front portion 14 which extends from the front face is also exposed in this configuration and is accessible by a user. This inner surface supports a mouthpiece 32.

Applying a force to the front and rear portions 14, 16 of the body 12 causes the phone 10 to revert to the closed configuration.

Embodiments may be movable between an open and closed configuration by the application of a squeezing force without the provision of bi-stable material on the side walls as described above. In this case some other mechanism for actuating the bi-stable component may be provided.

The benefits of embodiments of the present invention are:
the body provides a support for the mouthpiece;
the body serves as a grip while using the keypad (the keypads of small devices are awkward to use as there is no grip); and
the body makes the phone longer in its open configuration and thus easier to hold to the ear (with small phones a user has to hold their arm higher, which is strenuous and uncomfortable).

The bi-stable fold in the intermediate portion of the body may be a single homogeneous material. Alternatively, the bi-stable fold could be made from a plurality of layers of different materials. For example, a back layer could be of a flexible but non-compressible material. A front layer could be of an elastic material. The front layer may be adhered to the back layer while being stretched in both x and y directions of the plane of the material. This would give the layered structure a build-in tension. When the bi-stable element folds, the tension of the inner layers is released in one direction. The tension cannot be released in the other direction as the element is form-stiffened in that direction. When unfolded, the alternative is the case.

In one arrangement, homogeneous bi-stable steel strips may be treated and rolled so that the tension is created.

An embodiment of the present invention has been described here as applied to a mobile phone. Alternatively, embodiments of the present invention may be applied to other small handheld electronic devices such as calculators, mobile gaming devices, handheld video recorders, electric notepads, electronic books, PDAs, personal stereos, dictating machines, etc . . . .

Furthermore, although the invention has described in relation to small handheld devices, it is envisaged that the concept may be applied to larger devices. For example, a two part lap-top in which the sides are pressed by a user to unfold the screen/keypad, or a display/presentation system where, for example, a TV-sized screen unfolds from the body of an LCD projector.

While this invention has been particularly shown and described with reference to preferred embodiments thereof, it will be understood by those skilled in the art that various changes in form and details may be made therein without departing from the scope of the invention as defined by the appended claims.

1. A handheld electronic device comprising a body, wherein said body comprises a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations.

2. A handheld electronic device according to claim 1, wherein said first, second and intermediate portions are formed from a single bi-stable component.

3. A handheld electronic device according to claim 2, wherein the bi-stable material is in the form of a bi-stable fold provided in the bi-stable component at the intermediate portion.

4. A handheld electronic device according to claim 1, wherein the body is folded in said first configuration whereby respective surfaces of said first and second portions are in facing opposition.

5. A handheld electronic device according to claim 4, wherein said surfaces in facing opposition in said first configuration are accessible by a user in said second configuration.

6. A handheld electronic device according to claim 5, wherein at least a portion of one of said surfaces comprises a display.

7. A handheld electronic device according to claim 5, wherein at least a portion of one of said surfaces comprises one or more buttons.

8. A handheld electronic device according to claim 2, wherein the body further comprises two side walls, at least a portion of one or both side walls comprising a portion of said bi-stable component.

9. A handheld electronic device according to claim 8, wherein the side walls have at least one contact area for contacting by a user's hand, whereby the application of a squeezing force to the two contact areas causes the bi-stable component to move between its two stable configurations thereby causing the body to move between the first and second configurations.

10. A handheld electronic device according to claim 1, wherein the bi-stable material comprises a plurality of layers having a laminated structure with at least one of said layers being pre-stressed.

11. A handheld electronic device according to claim 1, wherein the electronic device is at least one of a mobile gaming device, a mobile phone, a hand-held video recorder, an electronic note pad, an electronic book, a PDA, a calculator, a personal stereo and a dictating machine.

12. A handheld electronic device according to claim 1, wherein said first portion comprises an ear-piece and said second portion comprises a mouth-piece.

13. A housing for a handheld electronic device, said housing comprising a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations.

14. A method of using a handheld electronic device comprising a body, wherein said body comprises a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations, wherein said first and second portions are moved between said first configuration and said second configuration by the application of a squeezing force applied by a user's hand.

15. An electronic device comprising a body, wherein said body comprises a first portion, a second portion and an intermediate portion, said intermediate portion connecting the first and second portions, said first and second portions being movable relative to each other between a first configuration and a second configuration, said intermediate portion being formed of a bi-stable material which has two stable configurations corresponding to said first and second configurations.
